(19) United States
(12) Patent Application Publication
(10) Pub. No.: US 2004/0251810 A1
(43) Pub. Date: Dec. 16, 2004

(54) Photocatalyst sterilizing lamp

(76) Inventor: Fu-Yu Hsu, TaoYuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/460,359

(22) Filed: Jun. 13, 2003

(51) Int. Cl. H01J 63/04; H01J 1/62

(52) U.S. Cl. 313/489; 313/635; 313/573

(57) ABSTRACT

A photocatalyst sterilizing lamp is constructed to include an UV lamp body and a photocatalyst coating coated on the surface of the lamp body, the lamp body having non-coating zones surrounded by the photocatalyst coating for the passing of ultraviolet light from the UV lamp body to activate the photocatalyst of the photocatalyst coating.

### BACKGROUND OF THE INVENTION

1. Field of the Invention

The present invention relates to sterilizing lamps and, more specifically, to a photocatalyst sterilizing lamp, which has non-coating zones evenly arranged in the photocatalyst coating for the passing of UV light to effectively activate the photocatalyst coating.

2. Description of the Related Art

Following fast development of industries and increase of the number of motor vehicles, the problem of air pollution becomes more and more series in most countries around the world. In order to breathe clean air, air conditioners, air purifiers, ventilators with wire gauze filters and the like may be used. However, these devices can simply remove solid matters from air. In recent years, various nanostructured photocatalysts have been developed for use with ultraviolet light sources to sterilize air. When a photocatalyst radiated by ultraviolet light, oxygen and water in air are caused to react and to produce negative oxygen ions and hydroxide free radicals. When encountered organic substances in air, negative oxygen ions transfer electrons to organic substances, and hydroxide free radicals catch electrons from organic substances. During the process, organic substances are caused to decompose into carbon dioxide and water. By means of the aforesaid chemical reaction, photocatalysts cause an oxidation to kill germs in air.

Various photocatalytic sterilizing products have been commercialized. However, the structural or space arrangement between the catalyst (for example, TiO₂) and the light source (for example, ultraviolet lamp) affects the sterilizing effect.

FIGS. 1A˜1C show a photocatalyst sterilizing lamp according to the prior art. This structure of photocatalyst sterilizing lamp is comprised of an UV lamp tube 11 and a photocatalyst coating 12 covered on the surface of the UV lamp tube 11. Because the photocatalyst coating 12 covers the whole area of the surface of the UV lamp tube 11 (except the base at each end of the lamp tube), less amount of UV energy passes out of the photocatalyst coating 12, resulting in a low photocatalyst ionizing (activating) effect. Further, because the photocatalyst coating 12 is smoothly covered on the surface of the UV lamp tube 11, currents of air pass over the surface of the photocatalyst sterilizing lamp rapidly, resulting in a short air and photocatalyst contact time. Therefore, this design of photocatalyst sterilizing lamp is less effect in killing germs in air.

### SUMMARY OF THE INVENTION

The present invention has been accomplished under the circumstances in view. It is the main object of the present invention to provide a photocatalyst sterilizing lamp, which has non-coating zones evenly arranged in the photocatalyst coating for the passing of UV light to effectively activate the photocatalyst coating. It is another object of the present invention to provide a photocatalyst sterilizing lamp, which prolongs air and photocatalyst contact time, enhancing the photocatalytic effect.

To achieve these and other objects of the present invention, the photocatalyst sterilizing lamp comprises an UV lamp body and a photocatalyst coating coated on the surface of the lamp body, the lamp body having non-coating zones surrounded by the photocatalyst coating for the passing of ultraviolet light from the UV lamp body to activate the photocatalyst of the photocatalyst coating.

### BRIEF DESCRIPTION OF THE DRAWINGS

FIG. 1A is an elevational view of a photocatalyst sterilizing lamp according to the prior art.

FIG. 1B is a cross-sectional view in an enlarged scale of the photocatalyst sterilizing lamp shown in FIG. 1.

FIG. 1C is a longitudinal view in section in an enlarged scale of a part of the photocatalyst sterilizing lamp shown in FIG. 1.

FIG. 2 is an elevational view of a photocatalyst sterilizing lamp according to the present invention.

FIG. 3 is an enlarged view of a part of the photocatalyst sterilizing lamp shown in FIG. 2.

FIG. 4 is a partial view of an alternate form of the photocatalyst sterilizing lamp according to the present invention.

FIG. 5 is a partial view of another alternate form of the photocatalyst sterilizing lamp according to the present invention.

FIG. 6 is a schematic longitudinal sectional view showing the action of the photocatalyst sterilizing lamp of FIG. 2.

FIG. 7 is a schematic cross-sectional view showing the action of the photocatalyst sterilizing lamp of FIG. 2.

FIG. 8 is an elevational view of still another alternate form of the photocatalyst sterilizing lamp according to the present invention.

FIG. 9 is a schematic sectional view of still another alternate form of the photocatalyst sterilizing lamp according to the present invention.

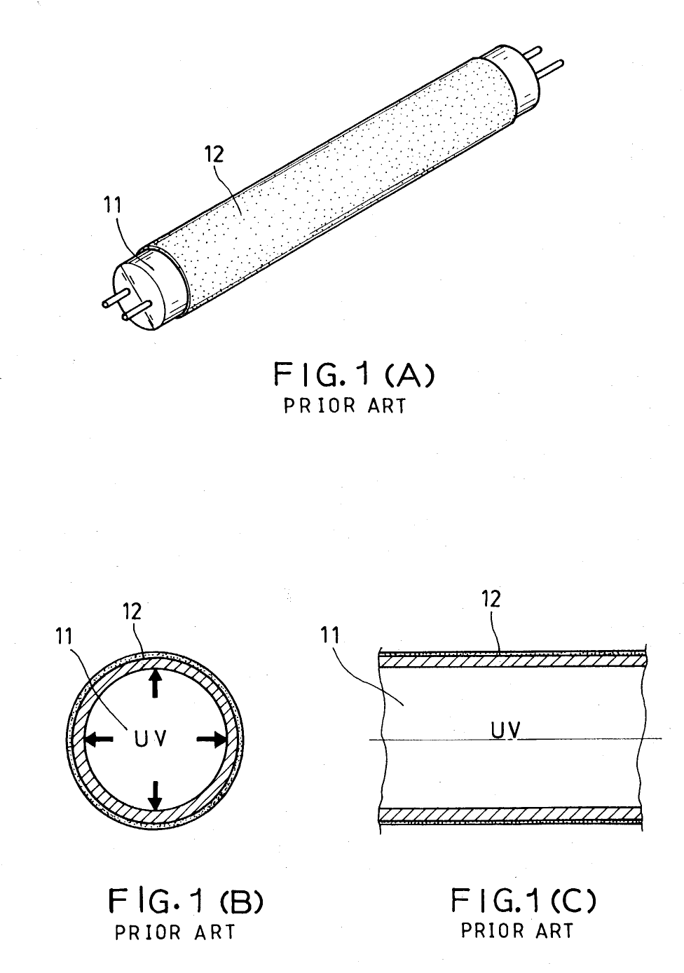

### DETAILED DESCRIPTION OF THE PREFERRED EMBODIMENT

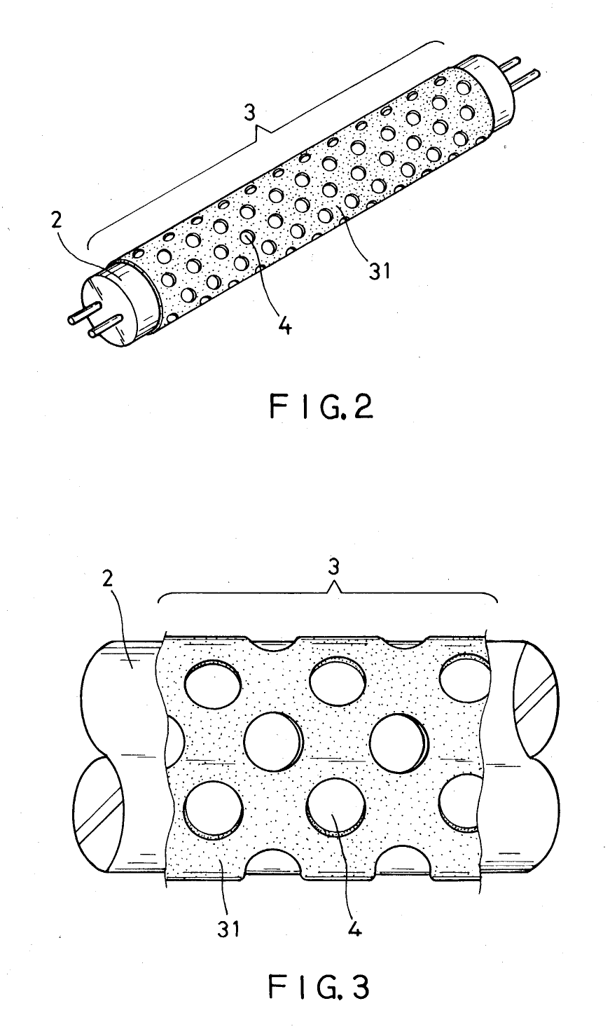

Referring to FIGS. 2˜3, a photocatalyst sterilizing lamp is shown comprising an UV (ultraviolet) lamp body 2 and a photocatalyst coating 3 formed of a photocatalyst 31 and coated on the surface of the UV lamp body 2. Non-coating zones 4 are formed in the photocatalyst coating 3 on the surface of the UV lamp body 2 for the passing of ultraviolet light from the UV lamp body 2 to activate the photocatalyst 31. According to the embodiment shown in FIGS. 2 and 3, the non-coating zones 4 are formed of evenly distributed through holes in the photocatalyst coating 3. The through holes forming the non-coating zones may have any of a variety of shapes, for example, circular shape.

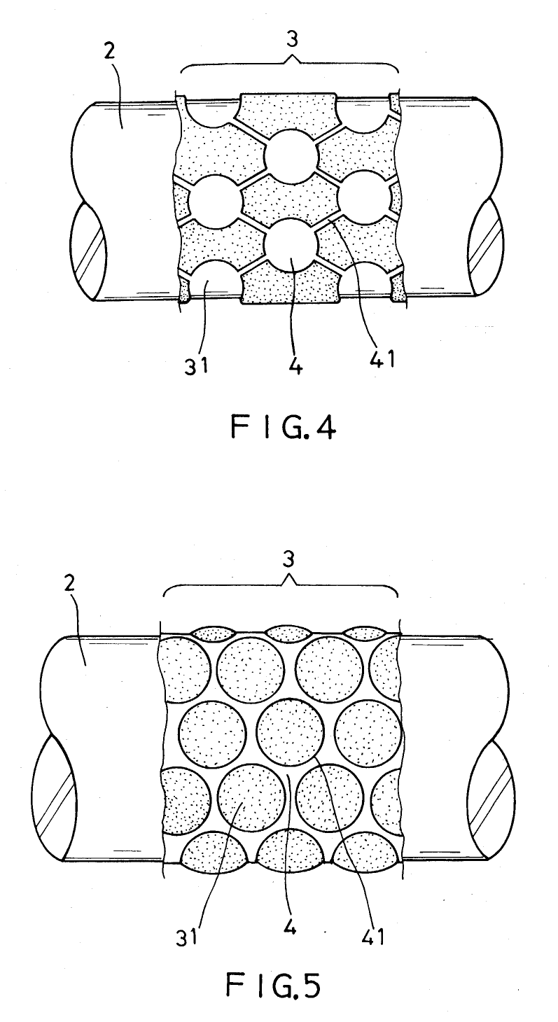

FIG. 4 shows an alternate form of the present invention. According to this embodiment, the non-coating zones (circular through holes) 4 are connected by connection portions 41.

FIG. 5 shows another alternate form of the present invention. According to this embodiment, the photocatalyst 31 of the photocatalyst coating 3 forms a plurality of evenly distributed raised portions on the surface of the UV lamp body 2 and separated from one another by the non-coating zones 4 and the connection portions 41.

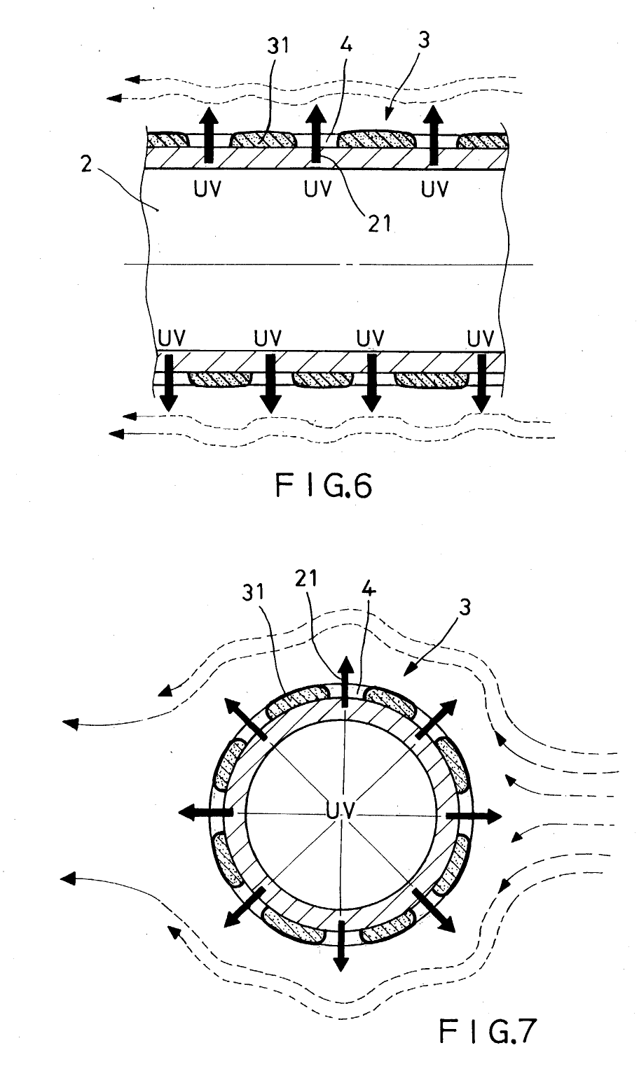

Referring to FIGS. 6 and 7 and FIGS. 2˜5 again, the total area of the non-coating zones 4 is smaller than the total area of the photocatalyst coating 3. The ideal ratio between the total area of the non-coating zones 4 and the photocatalyst coating 3 is ¼˜⅛:1. When the UV lamp body 2 turned on, about ¾˜⅞ of the photocatalyst coating 3 is radiated by ultraviolet light 21 from the UV lamp body 2, producing a satisfactory ionized effect to effectively sterilize surrounding air. Further, because the non-coating zones 4 are surrounded by the photocatalyst coating 3, the non-smoothness surface of the photocatalyst sterilizing lamp forms an air buffering area to buffer passing-by currents of air, prolonging air and photocatalyst contact time, and therefore the sterilizing effect of the photocatalyst sterilizing lamp is enhanced. Further, the photocatalyst 31 can be obtained from any of a variety of oxide compounds such as TiO₂, ZnO, SnO₂, SrTiO₃, WO₃, Bi₂O₃, and Fe₂O₃. The best choice is TiO₂.

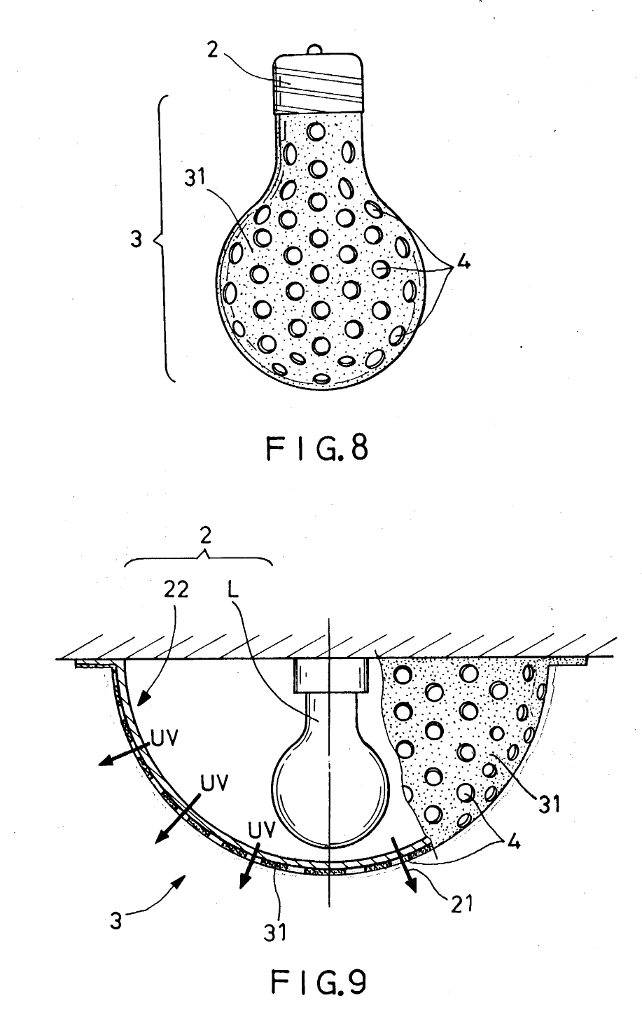

In the aforesaid embodiments, the UV lamp body 2 is a linear UV lamp tube. Alternatively, the UV lamp body 2 can be an UV lamp bulb as shown in FIG. 8, or the combination of an ultraviolet lamp bulb L and a lampshade 22. The lampshade 22 admits light, so that light rays 21 pass from the bulb L through the non-coating zones 4 to the outside of the photocatalyst sterilizing lamp to activate the photocatalyst 31. Further, an annular UV lamp tube, or light emitting diode may be used to substitute for the linear UV lamp tube shown in FIG. 2. The wavelength of the ultraviolet light of the UV lamp body 2 can be within 200˜800 nm.

A prototype of photocatalyst sterilizing lamp has been constructed with the features of FIGS. 2˜9. The photocatalyst sterilizing lamp functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A photocatalyst sterilizing lamp comprising a lamp body and a photocatalyst coating formed of a photocatalyst coated on the surface of said lamp body, wherein said lamp body has a non-coating area formed of a plurality of openings in said photocatalyst coating.

2. The photocatalyst sterilizing lamp as claimed in claim 1, wherein said photocatalyst coating is comprised of a plurality of raised catalyst portions formed over the surface of said lamp body.

3. The photocatalyst sterilizing lamp as claimed in claim 1, wherein said non-coating zones are linked to one another.

4. The photocatalyst sterilizing lamp as claimed in claim 1, wherein the total area of said non-coating zones is smaller than the total area of said photocatalyst coating.

5. The photocatalyst sterilizing lamp as claimed in claim 1, wherein said photocatalyst is selected from an oxide compound group including TiO₂, ZnO, SnO₂, SrTiO₃, WO₃, Bi₂O₃, and Fe₂O₃.

6. The photocatalyst sterilizing lamp as claimed in claim 1, wherein said lamp body is comprised of at least one lamp tube.

7. The photocatalyst sterilizing lamp as claimed in claim 6, wherein said lamp body comprises a lampshade covering said at least one lamp tube.

8. The photocatalyst sterilizing lamp as claimed in claim 1, wherein said lamp body is comprised of at least one lamp bulb.

9. The photocatalyst sterilizing lamp as claimed in claim 8, wherein said lamp body comprises a lampshade covering said at least one lamp bulb.

10. The photocatalyst sterilizing lamp as claimed in claim 1, wherein said lamp body is comprised of at least one light emitting diode.

11. The photocatalyst sterilizing lamp as claimed in claim 10, wherein said lamp body comprises a lampshade covering said at least one light emitting diode.

12. The photocatalyst sterilizing lamp as claimed in claim 1, wherein said lamp body is adapted to emit ultraviolet light.

13. The photocatalyst sterilizing lamp as claimed in claim 12, wherein the wavelength of the ultraviolet light emitted by said lamp body is within 200˜800 nm.
